(19) United States
(12) Patent Application Publication
(10) Pub. No.: US 2018/0128635 A1
(43) Pub. Date: May 10, 2018

(54) INFORMATION DISPLAY DEVICE, INFORMATION DISPLAY METHOD, AND INFORMATION DISPLAY PROGRAM

(71) Applicant: HONDA MOTOR CO., LTD, Tokyo (JP)

(72) Inventors: Yusuke Nakamura, Utsunomiya-shi (JP); Yoshitaka Mimura, Utsunomiya-shi (JP)

(21) Appl. No.: 15/804,057

(22) Filed: Nov. 6, 2017

(30) Foreign Application Priority Data
Nov. 8, 2016 (JP) 2016-218103

(51) Int. Cl. G01C 21/36; G01C 21/34; B60W 30/12; B60W 30/18; G05D 1/02

(52) U.S. Cl. CPC G01C 21/3644; G01C 21/3664; G01C 21/3461; G05D 2201/0213; B60W 30/18163; G05D 1/021; B60W 30/12

(57) ABSTRACT

An information display device includes: an automatic driving control unit configured to perform automatic driving, the automatic driving including at least road-tracking automatic driving in which a vehicle travels automatically while maintaining a traveling lane or a traveling road without setting a destination; and a display control unit configured to display at least one of a distance and a traveling time from a position of the vehicle to a branch point of the traveling road in which the vehicle travels or a point at which the road-tracking automatic driving ends on a display unit when the road-tracking automatic driving is performed by the automatic driving control unit.

### CROSS-REFERENCE TO RELATED APPLICATION

Priority is claimed on Japanese Patent Application No. 2016-218103, filed Nov. 8, 2016, the content of which is incorporated herein by reference.

### BACKGROUND OF THE INVENTION

### Field of the Invention

The invention relates to an information display device, an information display method, and an information display program.

### Description of Related Art

Recently, technology (hereinafter referred to as “automatic driving”) of automatically controlling at least one of acceleration/deceleration and steering of a vehicle has been studied. In this regard, a technique of acquiring a scheduled traveling route of a vehicle including an automatic driving section in which automatic driving is performed and showing a start point of the automatic driving section and a predicted arrival time of the vehicle at the start point is disclosed (for example, see Japanese Unexamined Patent Application, First Publication No. 2016-31297).

### SUMMARY OF THE INVENTION

However, in the technique described in Japanese Unexamined Patent Application, First Publication No. 2016-31297, when a route in which a vehicle travels is not set in advance, information on automatic driving such as a start point of the automatic driving section cannot be provided. Accordingly, there is a problem in that the desire of an occupant who manually drives a vehicle to start automatic driving without setting a route is not satisfied and convenience is not satisfactory.

An aspect of the invention is made in consideration of the above-mentioned circumstances and an object thereof is to provide an information display device, an information display method, and an information display program that can further improve convenience by displaying information on automatic driving even when a route in which a vehicle travels is not set.

The invention employs the following aspects to achieve the above-mentioned object.

(1) An information display device according to an aspect of the invention includes: an automatic driving control unit configured to perform automatic driving, the automatic driving including at least road-tracking automatic driving in which a vehicle travels automatically while maintaining a traveling lane or a traveling road without setting a destination; and a display control unit configured to display at least one of a distance and a traveling time from a position of the vehicle to a branch point of the traveling road in which the vehicle travels or a point at which the road-tracking automatic driving ends on a display unit when the road-tracking automatic driving is performed by the automatic driving control unit.

(2) In the aspect of (1), the display control unit may display at least one of the distance and the traveling time from the position of the vehicle to the branch point of the traveling road in which the vehicle travels or the point at which the road-tracking automatic driving ends in a part of a point guidance image in which information on event points included in the traveling road in which the vehicle travels is arranged sequentially from a position closest to the position of the vehicle.

(3) In the aspect of (2), the display control unit may display information indicating a section in which the road-tracking automatic driving is possible in an area corresponding to the section in which the road-tracking automatic driving is possible among areas interposed between display frames in which the information on the event points is displayed.

(4) In the aspect of (2) or (3), the display control unit may arrange and display an image indicating a road in which the road-tracking automatic driving is possible in the point guidance image.

(5) In the aspect of any one of (2) to (4), the information display device may further include a reception unit configured to receive an operation of instructing automatic lane change, and the display control unit may change the point guidance image to a point guidance image in which information on event points included in a branch road is arranged sequentially from a position closest to the position of the vehicle when an operation of changing the traveling road in which the vehicle travels to the branch road is received by the reception unit before the branch road.

(6) In the aspect of (5), the display control unit may arrange and display an image indicating a branch road in which the road-tracking automatic driving is possible in the changed point guidance image.

(7) In the aspect of any one of (1) to (6), the branch point may be a point other than a junction point of the traveling road in which the vehicle travels and a road connected to an exit of a toll road.

(8) An information display method according to an aspect of the invention, a computer performs road-tracking automatic driving in which a vehicle travels automatically while maintaining a traveling lane or a traveling road without setting a destination and displays at least one of a distance and a traveling time from a position of the vehicle to a branch point of the traveling road in which the vehicle travels or a point at which the road-tracking automatic driving ends on a display unit.

(9) An information display program according to a aspect of the invention causes a computer to execute a process of performing road-tracking automatic driving in which a vehicle travels automatically while maintaining a traveling lane or a traveling road without setting a destination and displaying at least one of a distance and a traveling time from a position of the vehicle to a branch point of the traveling road in which the vehicle travels or a point at which the road-tracking automatic driving ends on a display unit.

According to the aspects of (1), (8), and (9), when road-tracking automatic driving is performed, at least one of the distance and the traveling time from the position of the vehicle to a branch point or a point at which the road-tracking automatic driving ends is displayed on the display unit. Accordingly, according to the aspects of (1), (8), and (9), an occupant can be caused to recognize the branch point on the traveling road by the road-tracking automatic driving even when a route of the vehicle is not set. According to the aspects of (1), (8) and (9), an occupant can be caused to recognize a point at which the road-tracking automatic driving ends. As a result, according to the aspects of (1), (8), and (9), an occupant can be informed of an opportunity for the occupant to perform manual driving in the road-tracking automatic driving and it is possible to further improve convenience.

According to the aspects of (2) and (3), an occupant can be caused to easily recognize to what point in the point guidance image the road-tracking automatic driving is possible.

According the aspect of (4), since an image indicating a road in which the road-tracking automatic driving is possible is arranged and displayed in the point guidance image, an occupant can be caused to more easily recognize whether the road-tracking automatic driving is possible.

According to the aspect of (5), since the point guidance image is changed to an image in which information event points included in a branch road is arranged sequentially from a position closest to the start point of the branch road, the point guidance image can be updated before the vehicle actually enters the branch road. Accordingly, according to the aspect of (5), it is possible to cause an occupant to recognize an event point at an earlier time.

According to the aspect of (6), since an image indicating a branch road in which the road-tracking automatic driving is possible is arranged and displayed in the changed point guidance image, it is possible to cause an occupant to more easily recognize entrance of the vehicle into the branch road.

According to the aspect of (7), since at least one of the distance and the traveling time to a branch point other than a junction point of the traveling road in which the vehicle travels and a road connected to an exit of a toll road is displayed, a branch road connected to an interchange is not displayed and it is thus possible to suppress the frequency at which a branch point is displayed. Accordingly, according to the aspect of (7), it is possible to reduce trouble due to frequent display of a branch point.

### BRIEF DESCRIPTION OF THE DRAWINGS

FIG. 1 is a diagram illustrating a configuration of a vehicle system 1 including an automatic driving control unit 100;

FIG. 2 is a diagram illustrating a state in which a position and a posture of a vehicle M relative to a traveling lane L1 are recognized by a vehicle position recognizing unit 122;

FIG. 3 is a diagram illustrating an example of a configuration of a navigation device 50;

FIG. 4 is a diagram illustrating an example of event point information 531;

FIG. 5 is a diagram illustrating a state in which a target path is generated on the basis of a target lane when a route is determined by a navigation device 50;

FIG. 6 is a diagram illustrating a state in which a target path is generated on the basis of a target lane in a road-tracking automatic driving mode;

FIG. 7 is a diagram illustrating another state in which a target path is generated on the basis of a target traveling road in the road-tracking automatic driving mode;

FIG. 8 is a diagram illustrating another state in which a target path is generated on the basis of a target lane;

FIG. 9 is a diagram illustrating an example of a display screen including a point guidance image 300 and a route image 400 when a destination is set by the navigation device 50;

FIG. 10 is a diagram illustrating an example of a display screen including a point guidance image 300A and a route image 400A;

FIG. 11 is a diagram illustrating an example of a display screen including a point guidance image 300B and a route image 400B;

FIG. 12 is a diagram illustrating an example of a display screen including a point guidance image 300C and a route image 400C;

FIG. 13 is a diagram illustrating an example of a display screen including a point guidance image 300D and a route image 400D; and

FIG. 14 is a flowchart illustrating a process flow for displaying a point guidance image and a route image in the road-tracking automatic driving mode.

### DETAILED DESCRIPTION OF THE INVENTION

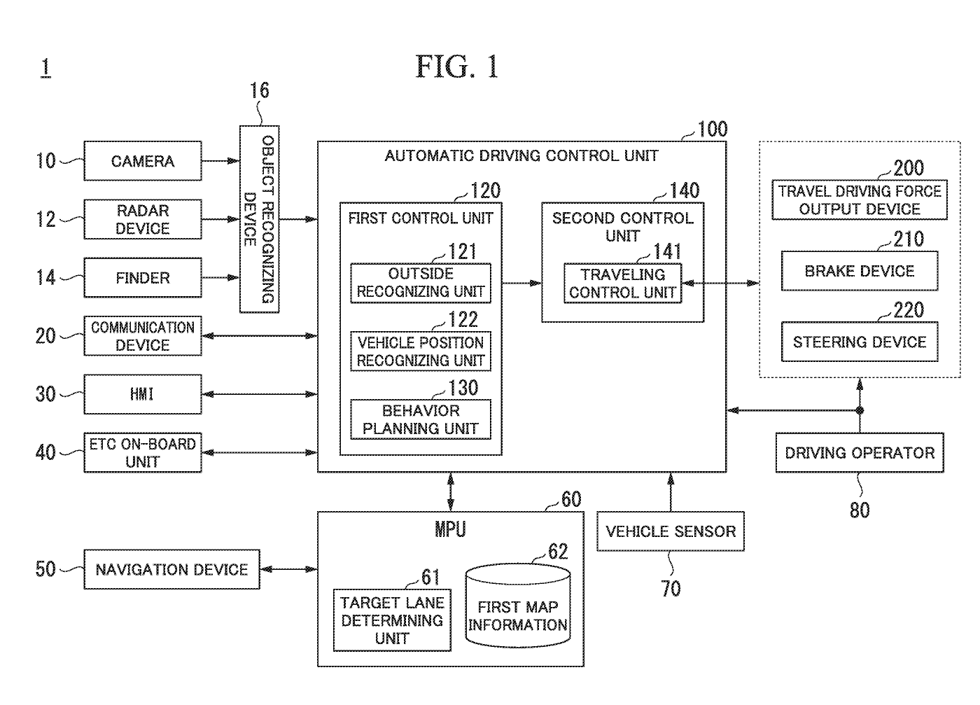

Hereinafter, a vehicle control system, an information display device, an information display method, and an information display program according to an embodiment of the invention will be described with reference to the accompanying drawings. FIG. 1 is a diagram illustrating a configuration of a vehicle system 1 including an automatic driving control unit 100. A vehicle in which the vehicle system 1 is mounted is, for example, a vehicle with two wheels, three wheels, or four wheels and a drive source thereof is an internal combustion engine such as a diesel engine or a gasoline engine, an electric motor, or a combination thereof. An electric motor operates using electric power generated by a power generator connected to the internal combustion engine or electric power discharged from a secondary battery or a fuel cell.

The vehicle system 1 includes, for example, a camera 10, a radar device 12, a finder 14, an object recognizing device 16, a communication device 20, a human machine interface (HMI) 30, an electronic toll collection system (ETC) on-board unit 40, a navigation device 50, a micro-processing unit (MPU) 60, a vehicle sensor 70, a driving operator 80, an automatic driving control unit 100, a travel driving force output device 200, a brake device 210, and a steering device 220. These devices or units are connected to each other via a multiplex communication line such as a controller area network (CAN) communication line, a serial communication line, or a radio communication network. The configuration illustrated in FIG. 1 is only an example and a part of the configuration may be omitted or another configuration may be added thereto.

The camera 10 is a digital camera using a solid-state imaging device such as a charge coupled device (CCD) or a complementary metal oxide semiconductor (CMOS). One or more cameras 10 are attached to arbitrary positions of the vehicle (hereinafter referred to as a vehicle M) in which the vehicle system 1 is mounted. When the front side is imaged, the camera 10 is attached to an upper part of a front windshield, a rear surface of a room mirror, or the like. The camera 10 images surroundings of the vehicle M, for example, periodically and repeatedly. The camera 10 may be a stereoscopic camera.

The radar device 12 radiates radio waves such as 1- to 10-millimeter waves to the surroundings of the vehicle M, detects radio waves (reflected waves) reflected by an object, and detects at least a position(a distance and a direction) of the object. One or more radar devices 12 are attached to arbitrary positions of the vehicle M. The radar device 12 may detect a position and a speed of an object using a frequency modulated continuous wave (FM-CW) method.

The finder 14 is a light detection and ranging or laser imaging detection and ranging (LIDAR) that measures scattered light in response to applied light and detects a distance to an object. One or more finders 14 are attached to arbitrary positions of the vehicle M.

The object recognizing device 16 performs sensor fusion processing on detection results from all or some of the camera 10, the radar device 12, and the finder 14 and recognizes a position, a type, a speed, and the like of an object. The object recognizing device 16 outputs the recognition result to the automatic driving control unit 100.

The communication device 20 communicates with another vehicle near the vehicle M, for example, using a cellular network, a Wi-Fi network, Bluetooth (registered trademark), dedicated short range communication (DSRC), or the like or communicates with various server devices via a radio base station such as VICS (registered trademark).

The HMI 30 presents a variety of information to an occupant of the vehicle M and receives an input operation from the occupant. The HMI 30 includes various display devices, speakers, buzzers, touch panels, switches, and keys. Operation units such as a touch panel, a switch, and a key in the HMI 30 serve as a first reception unit that receives a first operation of switching a driving mode of the vehicle M to an automatic driving mode. The automatic driving mode includes, for example, a normal automatic driving mode in which the vehicle M travels automatically along a route to a destination and a road-tracking automatic driving mode in which a traveling lane is maintained in a state in which a destination is not set. The road-tracking automatic driving mode maintains a traveling lane, but is not limited thereto. The road-tracking automatic driving mode may maintain a traveling road while appropriately changing a traveling lane. The road-tracking automatic driving mode can allow change of a traveling lane at the time of overtaking while maintaining a traveling road.

The HMI 30 includes, for example, a button for selecting the automatic driving mode. The HMI 30 serves as a second reception unit that receives a second operation of automatically switching a traveling lane of the vehicle M to a neighboring lane. The second operation includes an operation of instructing automatic changing of a traveling lane of the vehicle M to a lane adjacent to the lane in which the vehicle M travels currently (automatic lane change: ALC). The HMI 30 can receive an operation of instructing ALC at both a time at which a manual driving mode is performed and a time at which the automatic driving mode is performed.

The ETC on-board unit 40 includes an attachment portion to which an ETC card is attached and a radio communication unit that communicates with an ETC road-side unit installed in a gate of a roll road. The radio communication unit may be shared by the communication device 20. The ETC on-board unit 40 exchanges information of an entrance tollgate or an exit tollgate by communicating with the ETC road-side unit. The ETC road-side unit determines a billing fee for an occupant of the vehicle M on the basis of such information and performs a billing process.

The navigation device 50 calculates a route in which the vehicle M travels and guides a user to the route. The navigation device 50 shows a variety of information in a traveling road of the vehicle M even when a route in which the vehicle M travels is not determined. Details of the navigation device 50 will be described later.

The MPU 60 serves as, for example, a target lane determining unit 61 and stores first map information 62 in a storage device such as an HDD or a flash memory. The target lane determining unit 61 divides a route supplied from the navigation device 50 into a plurality of blocks (for example, every 100 [m] in a vehicle traveling direction) and determines a target lane for each block with reference to the first map information 62. The target lane determining unit 61 determines in which lane from the leftmost the vehicle will travel.

When a branch point or a merging point is present in the route, the target lane determining unit 61 determines a target lane such that the vehicle M travels in a rational traveling route for going to a branch destination. The MPU 60 determines whether automatic driving is possible along the determined recommended lane. Accordingly, the MPUT 60 determines whether a section included in the route searched for by the navigation device 50 is a section in which automatic driving is possible or a section in which automatic driving is not possible.

The first map information 62 is map information which is more precise than a navigation map DB 53 in the navigation device 50. The first map information 62 includes, for example, information of a center of a lane or information of a boundary of a lane. The first map information 62 may include road information, traffic regulation information, address information (addresses and postal codes), facility information, and phone number information. The road information includes information indicating a type of a road such as an expressway, a toll road, a national road, and a prefectural road or information such as the number of lanes of a road, a width of each lane, a gradient of a road, a position of a road (three-dimensional coordinates including longitude, latitude, and height), curvatures of curves of a road, positions of merging and branch points of a lane, and signs disposed on a road. The first map information 62 may be updated from time to time by accessing another device using the communication device 20.

The vehicle sensor 70 includes a vehicle speed sensor that detects a speed of the vehicle M, an acceleration sensor that detects acceleration, a yaw rate sensor that detects an angular velocity around a vertical axis, and a direction sensor that detects a direction of the vehicle M.

The driving operator 80 includes, for example, an accelerator pedal, a brake pedal, a shift lever, a steering wheel, and other operators. A sensor that detects an amount of operation or performing of an operation is attached to each driving operator 80, and a detection result thereof is output to the automatic driving control unit 100, the travel driving force output device 200, and one or both of the brake device 210 and the steering device 220.

The automatic driving control unit 100 includes, for example, a first control unit 120 and a second control unit 140. The first control unit 120 and the second control unit 140 are embodied by causing a processor such as a central processing unit (CPU) to execute a program (software). Some or all of functions of the first control unit 120 and the second control unit 140 which will be described below may be embodied by hardware such as a large scale integration (LSI), an application specific integrated circuit (ASIC), or a field-programmable gate array (FPGA) or may be embodied by software and hardware in cooperation.

The first control unit 120 includes, for example, an outside recognizing unit 121 a vehicle position recognizing unit 122, and a behavior planning unit 130.

The outside recognizing unit 121 recognizes states such as positions, speeds, and accelerations of neighboring vehicles on the basis of information input from the camera 10, the radar device 12, and the finder 14 via the object recognizing device 16. A position of a neighboring vehicle may be indicated by a representative point such as the center of gravity or a corner of the neighboring vehicle or may be indicated by an area which is expressed by an outline of the nearby vehicle. A “state” of a neighboring vehicle may include an acceleration, a jerk, or a “behavior condition” of the neighboring vehicle (for example, whether lane change is being performed or is intended). The outside recognizing unit 121 may recognize guard rails, telephone poles, parked vehicles, pedestrians, and other objects, in addition to the neighboring vehicles.

The vehicle position recognizing unit 122 recognizes, for example, a lane (a traveling lane) in which the vehicle M travels and a position and a posture of the vehicle M relative to the traveling lane. The vehicle position recognizing unit 122 recognizes the traveling lane, for example, by comparing a pattern of road defining lines near the vehicle M recognized from an image captured by the camera 10 with a pattern of road defining lines (for example, an arrangement of solid lines and dotted lines) acquired from the first map information 62. In the recognition, the position of the vehicle M acquired from the navigation device 50 or processing results of an inertial navigation system (INS) may be considered.

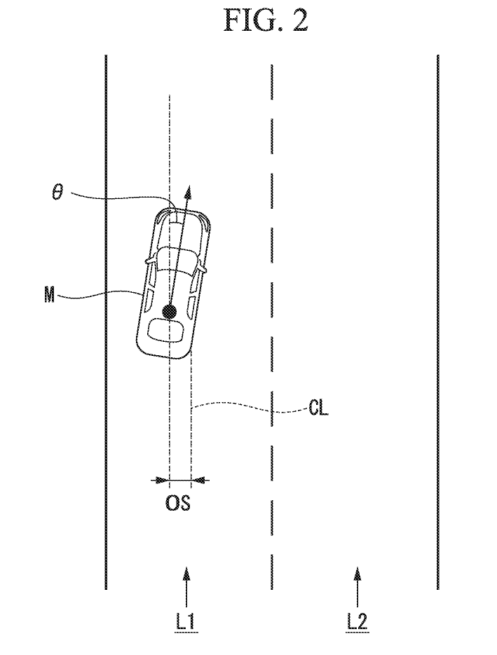

The vehicle position recognizing unit 122 recognizes, for example, a position and a posture of the vehicle M relative to the traveling lane. FIG. 2 is a diagram illustrating a state in which position and a posture of the vehicle M relative to the traveling lane L1 are recognized by the vehicle position recognizing unit 122. The vehicle position recognizing unit 122 recognizes, for example, a separation OS from a traveling lane center CL of a reference point (for example, the center of gravity) of the vehicle M and an angle θ formed by a traveling direction of the vehicle M and a line of the traveling lane center CL as a position and a posture of the vehicle M relative to the traveling lane L1. Instead, the vehicle position recognizing unit 122 may recognize a position of the reference point of the vehicle M relative to one edge of the traveling lane L1 or the like as a position of the vehicle M relative to the traveling lane. The relative position of the vehicle M recognized by the vehicle position recognizing unit 122 is supplied to the target lane determining unit 61 and the behavior planning unit 130.

The behavior planning unit 130 determines events which are sequentially performed in automatic driving such that the vehicle travels in the target lane determined by the target lane determining unit 61 and measures for coping with surrounding conditions of the vehicle M can be taken. Examples of the events include a constant-speed traveling event in which a vehicle travels in the same traveling lane at a constant speed, a following traveling event in which a vehicle follows a preceding vehicle, a lane change event, a merging event, a branching event, an emergency stop event, and a handover event in which automatic driving is ended and switched to manual driving. In the course of performing such events, behavior for avoidance may be planned on the basis of surrounding conditions of the vehicle M (such as presence of a neighboring vehicle or a pedestrian and lane narrowing due to road construction).

The behavior planning unit 130 generates a target path in which the vehicle M will travel in the future. A target path includes, for example, a speed element. For example, a target path is generated as a set of target points (path points) at which a vehicle will arrive at a plurality of reference times in the future in a state in which the reference times are set every predetermined sampling time (for example, every several tenths of a [see]). Accordingly, when a gap between path points is large, it means that a vehicle travels at a high speed in a section between the path points.

The second control unit 140 includes a traveling control unit 141. The traveling control unit 141 controls the travel driving force output device 200, the brake device 210, and the steering device 220 such that the vehicle M passes through the target path generated by the behavior planning unit 130 at scheduled times.

The travel driving force output device 200 outputs a travel driving force (a torque) for allowing a vehicle to travel to driving wheels. The travel driving force output device 200 includes, for example, a combination of an internal combustion engine, an electric motor, and a transmission and an ECU that controls them. The ECU controls the above-mentioned configuration on the basis of information input from the traveling control unit 141 or information input from the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of information input from the traveling control unit 141 such that a brake torque based on a braking operation is output to vehicle wheels. The brake device 210 may include a mechanism for transmitting a hydraulic pressure generated by an operation of a brake pedal included in the driving operator 80 to the cylinder via the master cylinder as a backup. The brake device 210 is not limited to the above-mentioned configuration, and may be an electronically controlled hydraulic brake device that controls an actuator on the basis of information input from the traveling control unit 141 such that the hydraulic pressure of the master cylinder is transmitted to the cylinder.

The steering device 220 includes, for example, a steering ECU and an electric motor.

The electric motor changes a direction of turning wheels, for example, by applying a force to a rack-and-pinion mechanism. The steering ECU drives the electric motor on the basis of information input from the traveling control unit 141 or information input from the driving operator 80 to change the direction of the turning wheels.

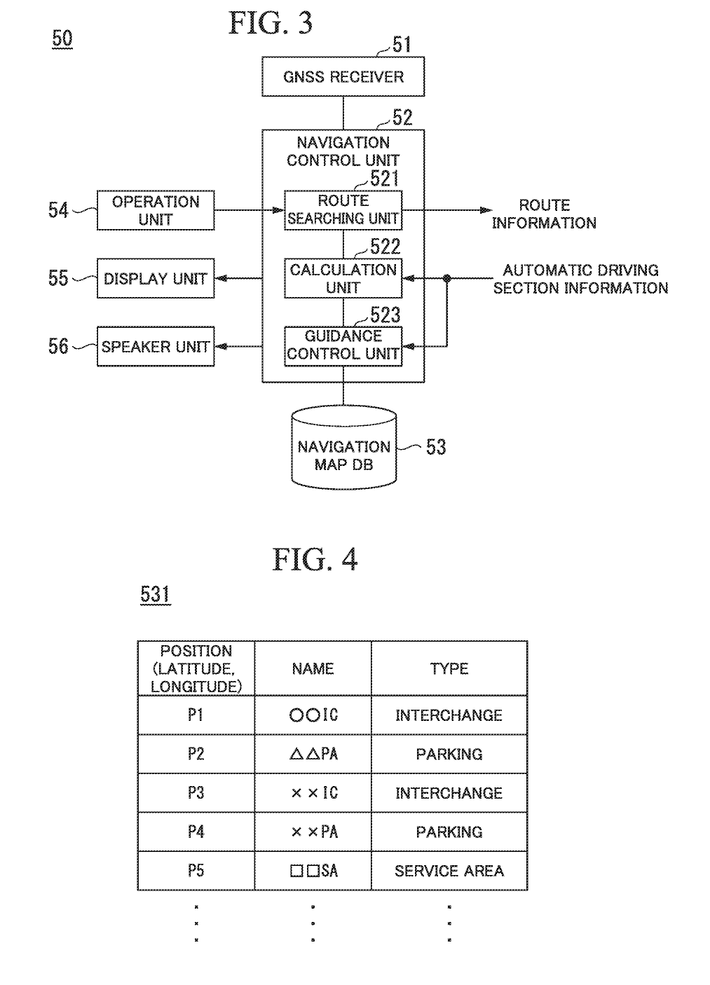

The navigation device 50 in the vehicle system 1 will be described below. FIG. 3 is a diagram illustrating an example of a configuration of the navigation device 50. The navigation device 50 includes, for example, a global navigation satellite system (GNSS) receiver 51, a navigation control unit 52, a navigation map DB 53, an operation unit 54, a display unit 55, and a speaker unit 56.

The GNSS receiver 51 specifies a position of a vehicle M on the basis of signals received from GNSS satellites. The position of the vehicle M may be specified or corrected by an INS using the output of the vehicle sensor 70.

The navigation map DB 53 is stored in a storage device such as a hard disk drive (HDD) or a flash memory. The navigation map DB 53 is a database in which event point information is included in map information. The map information is, for example, information in which a road shape is expressed by links indicating roads and nodes connected by the links. The map information may include detailed information of roads such as curvatures of roads. An event point is a point of which name information for specifying a name of a facility or a point is added to position information of the point in the navigation map DB 53.

FIG. 4 is a diagram illustrating an example of event point information 531. The event point information 531 is, for example, information in which position information, name information, and type information are correlated with each other. The type information is information indicating a type of a facility on a road. The event point information may be, for example, information which is included in point-of-interest (POI) information. The event point information includes, for example, a parking area, a service area, an interchange, a junction, and a tollgate in case of a toll road.

The operation unit 54 includes a touch panel, buttons, keys, and the like for operating the navigation device 50. The display unit 55 is a liquid crystal display that displays a route which is guided by the navigation device 50 or the like. The speaker unit 56 is a speech output device that outputs speech for guiding a route in the navigation device 50. Some or all of the operation unit 54, the display unit 55, and the speaker unit 56 may be shared by the HMI 30.

The navigation control unit 52 includes, for example, a route searching unit 521, a calculation unit 522, and a guidance control unit 523. The route searching unit 521, the calculation unit 522, and the guidance control unit 523 are embodied by causing a processor such as a CPU to execute a program (software). Some or all of functions of the route searching unit 521, the calculation unit 522, and the guidance control unit 523 may be embodied by hardware such as an LSI, an ASIC, or an FPGA or may be embodied in cooperation of software and hardware.

The route searching unit 521 determines, for example, a route from the position of the vehicle M (or an arbitrary input position) specified by the GNSS receiver 51 to a destination input by an occupant using the operation unit 54 with reference to the navigation map DB 53. The navigation control unit 52 supplies the determined route information to the MPU 60.

The calculation unit 522 calculates a distance between a current position of the vehicle M and an event point. The calculation unit 522 estimates a traveling time until the vehicle M reaches the event point on the basis of the distance between the current position of the vehicle M and the event point. The calculation unit 522 may calculate a tune at which the vehicle M reaches the event point. The calculation unit 522 acquires automatic driving section information from the MPU 60. The automatic driving section information is information indicating whether a road in which the vehicle M travels currently or a road in which the vehicle M will travel in the future is a section in which automatic driving is possible or a section in which automatic driving is not possible. The road in which the vehicle M will travel in the future is one of a road which is included in the route and a road which is not included in the route but which is connected to the traveling lane of the vehicle M.

The guidance control unit 523 guides information on the traveling road in which the vehicle M travels using the display unit 55 and the speaker unit 56. The guidance control unit 523 corresponds to a display control unit that controls display of the display unit 55.

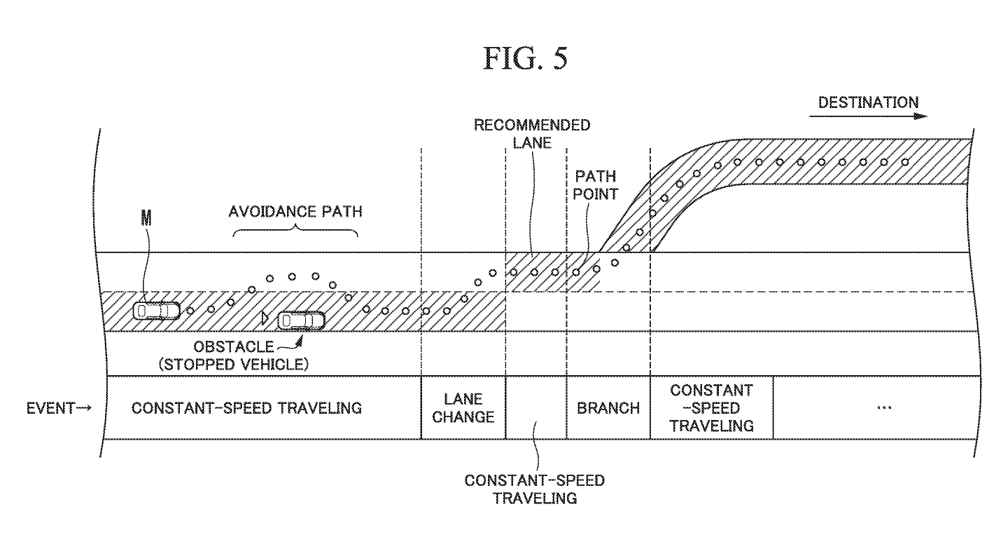

FIG. 5 is a diagram illustrating a state in which a target path is generated on the basis of a target lane when a route is determined by the navigation device 50. As illustrated in the drawing, the target lane is set to be convenient to traveling along the route to a destination. When the vehicle reaches a position prior a predetermined distance (which may be determined depending on a type of an event) to a switching point of the target lane, the behavior planning unit 130 starts a lane changing event, a branching event, a merging event, and the like. When it is necessary to avoid an obstacle during execution of each event, an avoidance path is generated as illustrated in the drawing. For example, the behavior planning unit 130 generates a plurality of candidates for the target path and selects an optimal target path at that time in view of safety and efficiency. In this way, the automatic driving mode allows the vehicle M to travel along the route to a destination.

In the above-mentioned vehicle system 1, the driving mode of the vehicle M is switched to a road-tracking automatic driving mode when an operation of selecting the automatic driving mode is performed using the HMI 30 in a state in which a destination is not set. The road-tracking automatic driving mode is a driving mode in which the vehicle M travels automatically while maintaining a traveling lane without setting a destination. Automatic traveling of the vehicle M in the road-tracking automatic driving mode means that the traveling lane at a time point at which the road-tracking automatic driving is started is maintained as well as possible by performing speed control and steering control of the vehicle M. The road-tracking automatic driving mode is set such that the vehicle M travels conveniently along the traveling lane while avoiding obstacles such as other vehicles if necessary.

The target lane determining unit 61 determines a lane in which the vehicle M travels currently as a target lane in the road-tracking automatic driving mode. The target lane determining unit 61 determines a lane in which the vehicle M travels currently as a target lane, but is not limited thereto and may determine an arbitrary lane such as a main lane other than an overtaking lane in a traveling road including the lane in which the vehicle M travels currently as a target lane.

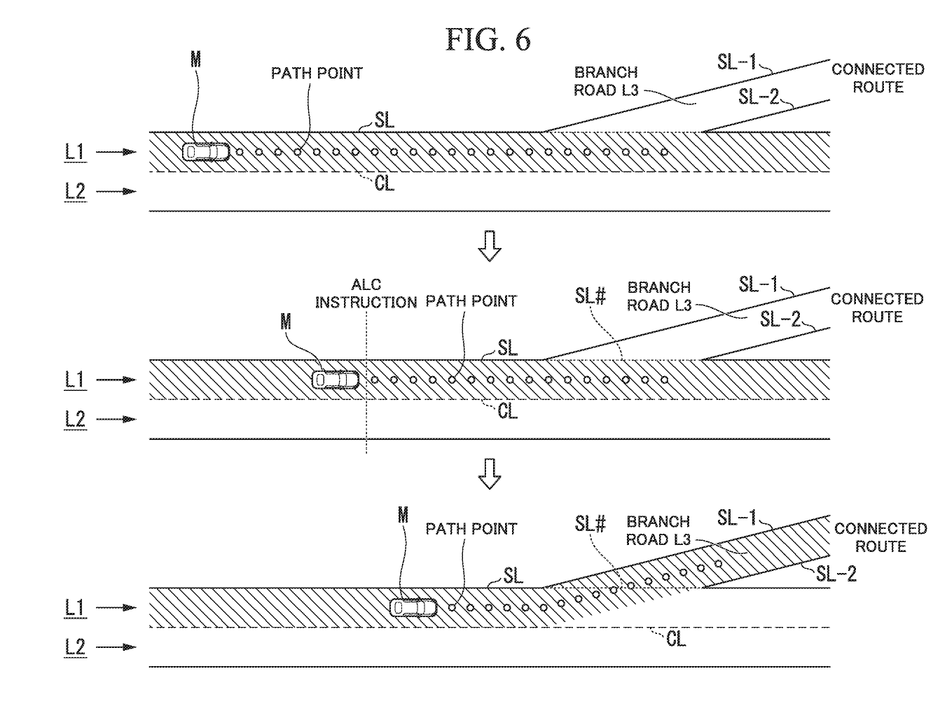

FIG. 6 is a diagram illustrating a state in which a target path is generated on the basis of a target lane in the road-tracking automatic driving mode. As illustrated in an upper part of FIG. 6, the target lane determining unit 61 determines a lane in which the vehicle M travels as a target lane. At this time, the target lane determining unit 61 determines a lane L1 between a traveling lane center CL and a traveling lane edge SL which are recognized by the vehicle position recognizing unit 122 as a target lane. The behavior planning unit 130 generates a target path along the determined target lane.

As illustrated in a middle part of FIG. 6, it is assumed that an automatic lane changing operation of changing the traveling lane to a lane included in a branch road is received by the HMI 30 before the vehicle enters the branch road connected to a connected road at a junction. In this case, the behavior planning unit 130 starts the lane changing event. The target lane determining unit 61 changes the traveling lane of the branch road to a target lane in response to starting of the lane changing event. At this time, the target lane determining unit 61 is supplied with recognition results of a road defining line SL# drawn between the traveling lane L1 and the branch road and road defining lines SL-1 and SL-2 drawn at both edges of the branch road from the vehicle position recognizing unit 122.

As illustrated in a lower part of FIG. 6, the target lane determining unit 61 determines a lane between the road defining lines SL-1 and SL-2 as a target lane. The behavior planning unit 130 generates a target path passing through the road defining line SL# along the determined target lane.

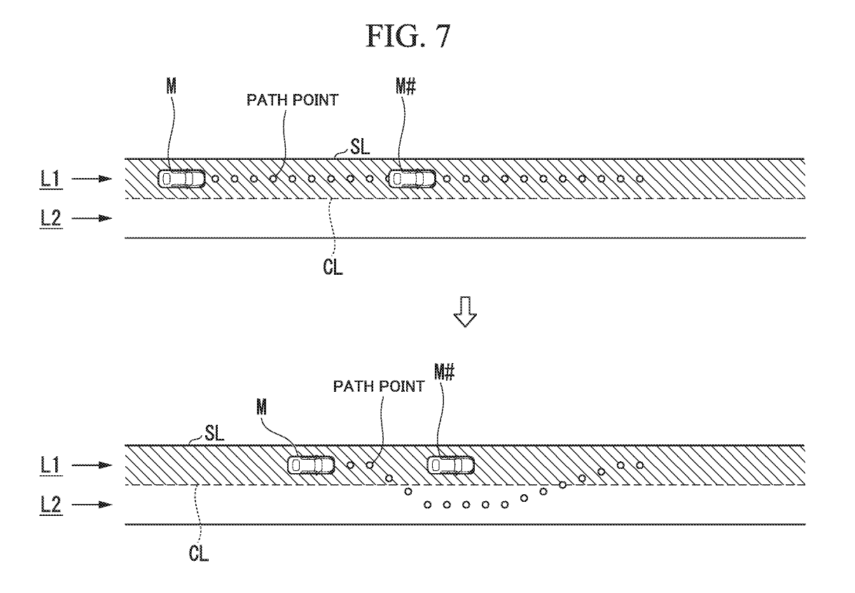

FIG. 7 is a diagram illustrating another state in which a target path is generated on the basis of a target traveling road in the road-tracking automatic driving mode. As illustrated in an upper part of FIG. 7, it is assumed that the target lane determining unit 61 recognizes that there is a preceding vehicle M# traveling in the same lane L1 as the vehicle M in a state in which the vehicle M travels while maintaining the traveling road in the road-tracking automatic driving mode. As illustrated in a lower part of FIG. 7, the behavior planning unit 130 generates a target path which is changed to a lane L2 and then is changed to the target lane L1 when a set speed of the vehicle M is higher a predetermined speed than the speed of the preceding vehicle M#. Accordingly, the target lane determining unit 61 can allow change of the traveling lane at the time of overtaking while maintaining the traveling road.

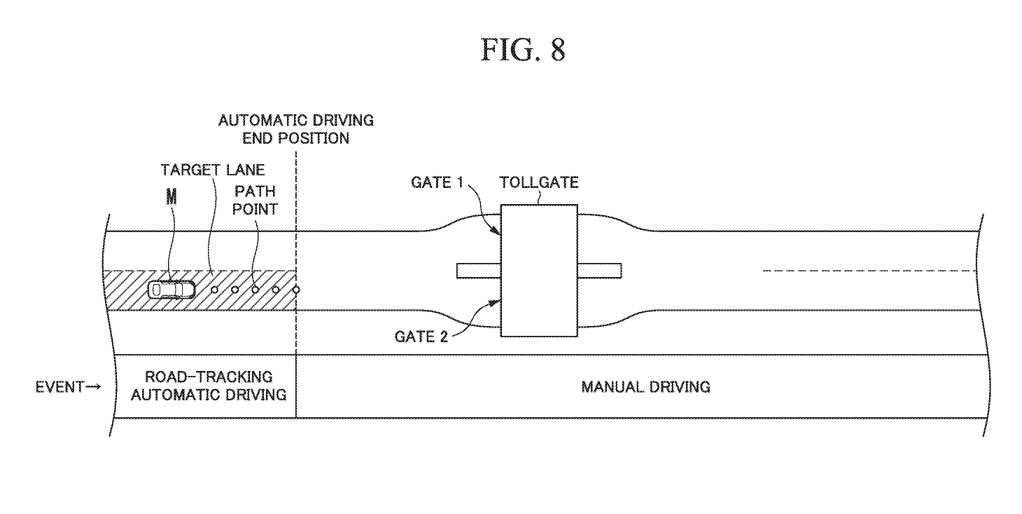

FIG. 8 is a diagram illustrating another state in which a target path is generated on the basis of a target lane. It is assumed that a road for entering a tollgate of a toll road is included in the traveling lane in the road-tracking automatic driving mode. When the traveling lane includes a road for entering a tollgate of a toll road, the behavior planning, unit 130 determines that a position of the vehicle M prior a predetermined distance to the position of the tollgate is a position at which the road-tracking automatic driving ends.

The behavior planning unit 130 determines the position at which the road-tracking automatic driving ends when the traveling lane includes a road for entering a tollgate of a toll road, but is not limited thereto. The behavior planning unit 130 may determine that a place in which determination of an occupant is required is a position at which the automatic driving ends.

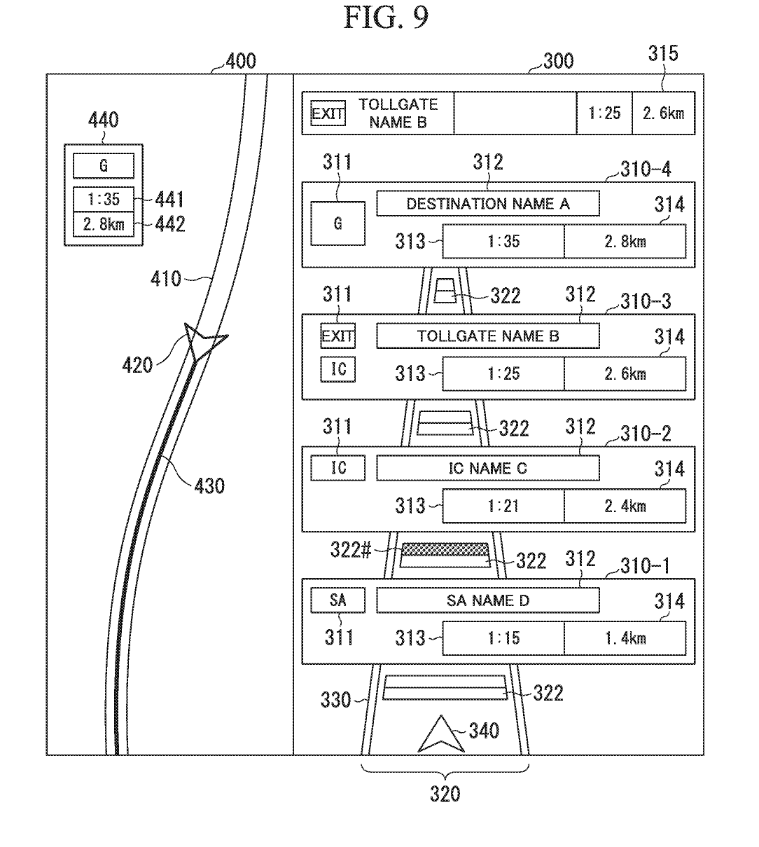

An operation of guiding an event point in a road in which the vehicle M travels using the navigation device 50 will be described below. FIG. 9 is a diagram illustrating an example of a display screen including a point guidance image 300 and a route image 400 when a destination is set by the navigation device 50.

The point guidance image 300 is an image in which display frames 310-1 to 310-4 in which information on event points included in a route from a traveling point of the vehicle M to a destination in the route searched for by the route searching unit 521 is displayed are arranged in the order from the traveling point of the vehicle M to the destination. In the example illustrated in FIG. 9, the event points include a service area with a name of “D,” an interchange with a name of “C,” a tollgate with a name of “B,” and a destination with a name of “A.”

Each display frame 310 includes an image 311 indicating a type of an event point, an image 312 indicating a name of an event point, an image 313 indicating a time at which the vehicle arrives at the event point, and an image 314 indicating a distance to the event point. The point guidance image 300 includes a tollgate information image 315 including an image indicating a name of the tollgate, an image indicating a time at which the vehicle arrives at the tollgate, and an image indicating a distance to the tollgate.

In an area between the lower end of the point guidance image 300 and the display frame 310-1 corresponding to the event point closest to the vehicle M among the display frames 310, a vehicle image 340 indicating a position of the vehicle M is displayed.

In an area interposed between the vehicle image 340 and the display frame 310-1 and areas interposed between the display frames 310, route images 320 are displayed. The route images 320 are images for showing that the event points corresponding to the display frames 310 are present on the route and presenting conditions of the routes between the event points. Each route image 320 includes a condition image 322 indicating a condition of the route between the event points. Regarding the condition of the route, for example, an area corresponding to a congested section is displayed as a red image 322#.

The point guidance image 300 includes a recommended route image 330. The recommended route image 330 is displayed in an area along the route image 320. The recommended route image 330 is an image indicating that the vehicle M travels along the route determined by the route searching unit 521. For example, when the vehicle M travels along the route determined by the route searching unit 521, the recommended route image 330 is displayed in a predetermined color (for example, green). When the vehicle M does not travel along the route determined by the route searching unit 521, the recommended route image 330 is not displayed in the point guidance image 300.

The route image 400 is an image indicating information indicating a traveling time or a distance from the traveling point of the vehicle M to a destination.

The route image 400 is displayed in parallel with the point guidance image 300. The route image 400 includes a traveling road image 410, a vehicle image 420, a recommended route image 430, and a destination information image 440.

The traveling road image 410 is an image that connects points on a map corresponding to points on a road on which the vehicle M travels. The vehicle image 420 is an image which is displayed at a point on the map corresponding to the current position of the vehicle M. The recommended route image 430 is an image that connects points on the map corresponding to points on the route determined by the route searching unit 521. When the vehicle M travels along the route determined by the route searching unit 521, the recommended route image 430 is displayed in a predetermined color (for example, green). The destination information image 440 includes an image 441 indicating a time at which the vehicle arrives at an event point and an image 442 indicating a distance to the event point.

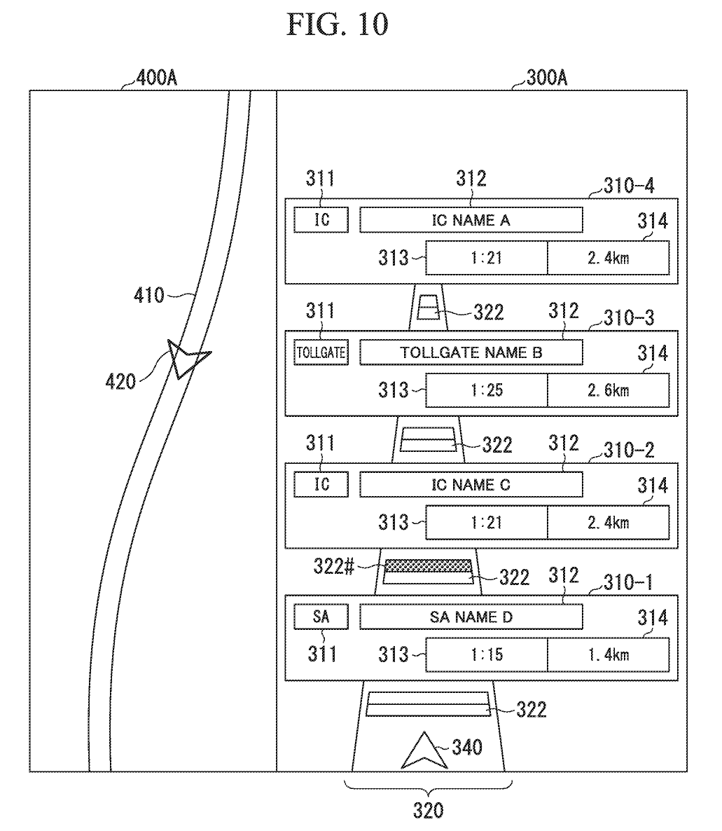

FIG. 10 is a diagram illustrating another example of display screen including a point guidance image 300A and a route image 400A. The guidance control unit 523 displays the point guidance image 300A and the route image 400A when a destination of the vehicle M is not set and the driving mode of the vehicle M is the manual driving mode. The point guidance image 300A includes a plurality of display frames 310 and a plurality of route images 320. The plurality of display frames 310 are arranged in the order of increasing distances from the position of the vehicle M. The route image 320 does not include the recommended route image 330. The route image 400A is an image in which the vehicle image 420 is superimposed on the traveling road image 410. The route image 400A does not include the recommended route image 430.

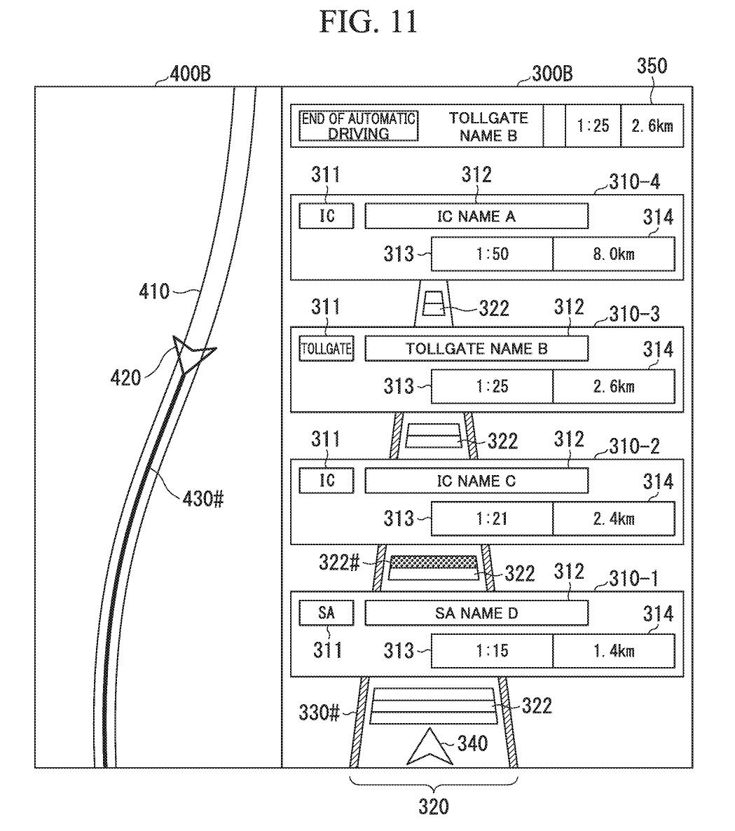

FIG. 11 is a diagram illustrating another example of a display screen including a point guidance age 300B and a route image 400B. The guidance control unit 523 displays the point guidance image 300B and the route image 400B when the driving mode of the vehicle M is the road-tracking automatic driving mode. The point guidance image 300B includes a plurality of display frames 310, a plurality of route images 320, a plurality of road-tracking traveling route images 330#, a vehicle image 340, and au end notification image 350. The plurality of display frames 310 are arranged in the order of increasing distances from the position of the vehicle

Each route image 320 includes a road-tracking traveling route image 330#. The road-tracking traveling route image 330# indicates a section in which the vehicle M can travel automatically while maintaining the traveling lane in the road-tracking automatic driving mode. The guidance control unit 523 displays the road-tracking traveling route image 330# in an image area corresponding to a section in which a target path is set in the road-tracking automatic driving mode by the MPU 60. The guidance control unit 523 acquires information indicating that a target path is set in a section from the current position of the vehicle M to a service area with a name of “D,” and a section from the service area with a name of “D” to an interchange with a name of “C,” and a section from the interchange with a name of “C” to a tollgate with a name of “B” from the MPU 60. Accordingly, the guidance control unit 523 displays the road-tracking traveling route images 330# in the area interposed between the vehicle image 340 and the display frame 310-1, the area interposed between the display frame 310-1 and the display frame 310-2, and the area interposed between the display frame 310-2 and the display frame 310-3.

The guidance control unit 523 is supplied with a determination result of determination that a position prior a predetermined distance to the position of the tollgate toward the vehicle M is as a position at which the road-tracking automatic driving ends. The guidance control unit 523 presents an image indicating that the road-tracking automatic driving mode is not possible after the position prior to the tollgate with a name of “B.” Specifically, the guidance control unit 523 does not display the road-tracking traveling route images 330# in a section from the tollgate with a name of “B” to the interchange with a name of “A.”

The end notification image 350 includes text of “END OF AUTOMATIC DRIVING” and information indicating the reason for the end of automatic driving. The information indicating the reason for the end of automatic driving is, for example, the tollgate name of “B.” The end notification image 350 includes an image indicating a time at which the vehicle M arrives at the tollgate and a distance to the tollgate. The end notification image 350 also includes an image indicating a traveling time until the vehicle M arrives at the tollgate.

The route image 400B includes a road-tracking traveling route images 430# instead of the recommended route image 430. The guidance control unit 523 displays the road-tracking traveling route images 430# on the basis of a route corresponding to the target path set by the behavior planning unit 130.

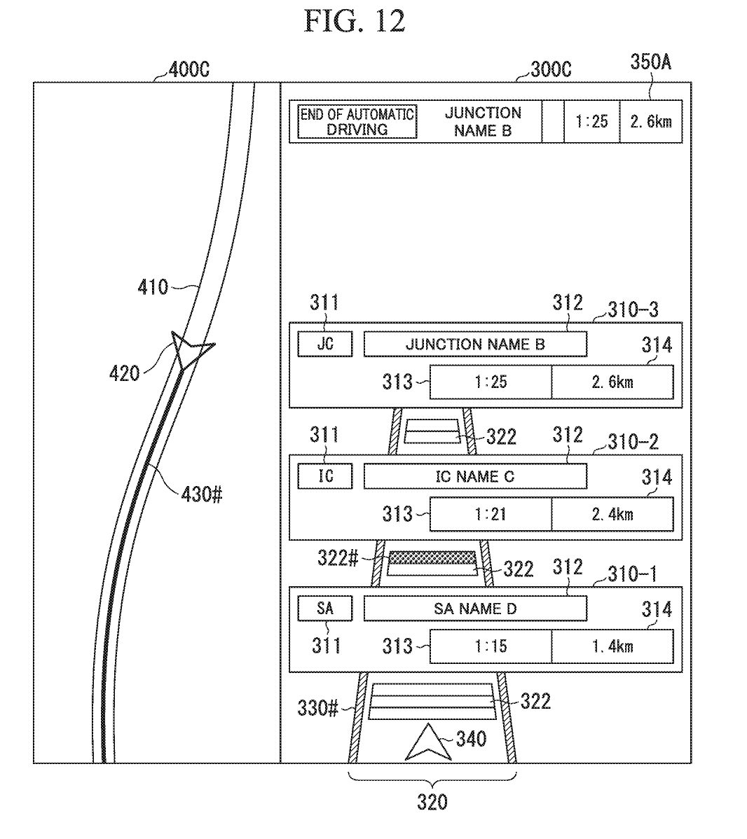

FIG. 12 is a diagram illustrating another example of a display screen including a point guidance image 300C and a route image 400C. The guidance control unit 523 displays display frames 310 corresponding to event points which are between the position of the vehicle M and a position of a junction when a road including the traveling lane is connected to the junction which branches to a connected road connected to the road in the road-tracking automatic driving mode. Specifically, when a service area and an interchange are present between the position of the vehicle M and the position of the junction, the guidance control unit 523 displays a display frame 310-1 corresponding to the service area, a display frame 310-2 corresponding to the interchange, and a display frame 310-3 corresponding to the junction. The guidance control unit 523 does not display the display frames 310 corresponding to the event points after the display frame 310-3 corresponding to the junction even when the vehicle M does not branch at the junction.

The guidance control unit 523 displays an end notification image 350A in the point guidance image 300C. The end notification image 350A includes text of “END OF AUTOMATIC DRIVING” and information indicating a reason for the end of automatic driving. The information indicating the reason for the end of automatic driving is, for example, the junction name of “B.” The end notification image 350A includes an image indicating a time at which the vehicle M arrives at the junction and a distance to the junction. The end notification image 350A may also include an image indicating a traveling time until the vehicle M arrives at the junction.

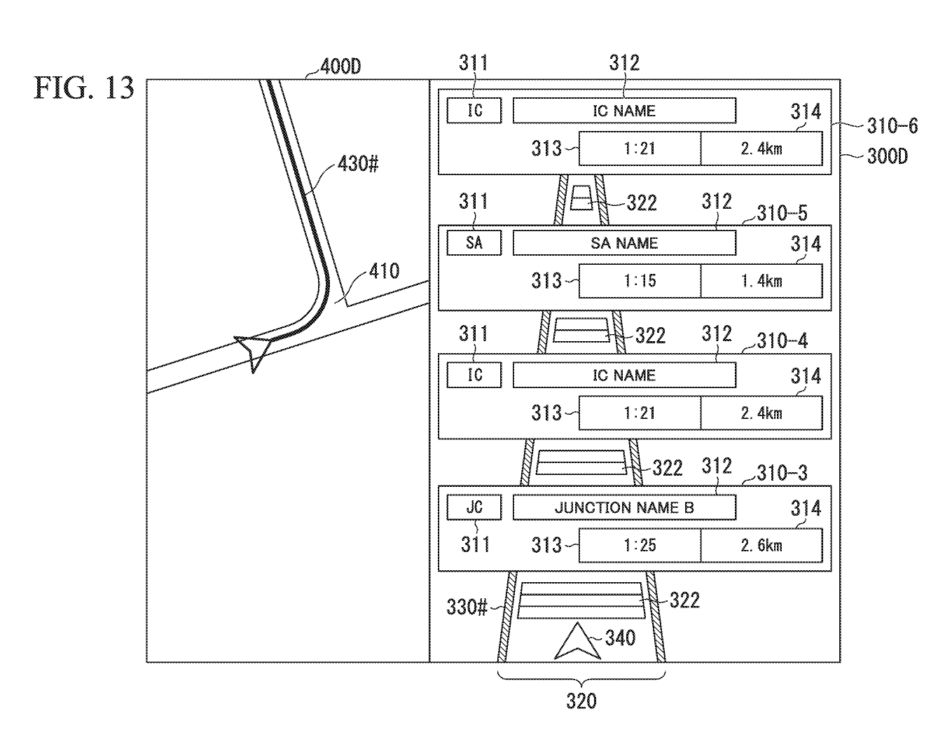

FIG. 13 is a diagram illustrating another example of a display screen including a point guidance image 300D and a route image 400D. The guidance control unit 523 changes an image to be displayed on the display unit 55 to the point guidance image 300D and the route image 400D when an operation of instructing automatic lane change is received in the road-tracking automatic driving mode and a lane after the automatic lane change is a lane included in a branch road. The point guidance image 300D is an image in which a display frame 310-3 corresponding to a junction and display frames 310-4 to 310-6 in which information associated with event points included in the branch road is displayed are arranged from a position closest to a start point of the branch road. The route image 400D includes a road-tracking traveling route images 430# indicating a traveling lane included in the branch road.

For example, when the point guidance image 300C including the end notification image 350A illustrated in FIG. 12 is displayed, it is assumed that the HMI 30 receives an operation of instructing automatic lane change of changing the traveling lane to a lane of the branch road before tire junction. When the operation of instructing automatic lane change is received, the guidance control unit 523 switches an image to be displayed on the display screen from the point guidance image 300C and the route image 400C to the point guidance image 300D and the route image 400D. Accordingly, the guidance control unit 523 can display the point guidance image 300D before it is recognized that the vehicle M enters the branch road from the navigation device 50.

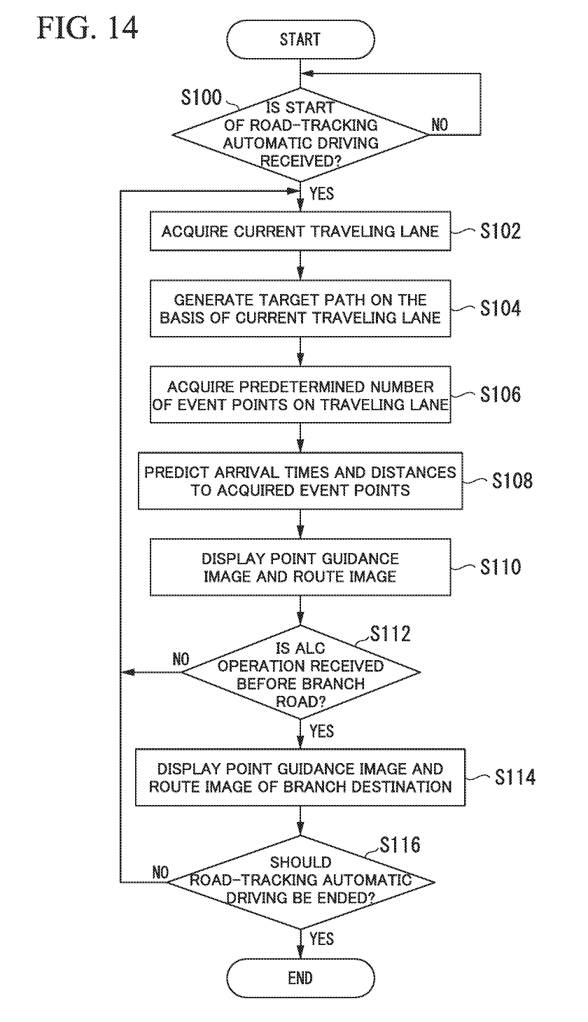

FIG. 14 is a flowchart illustrating a process flow for displaying a point guidance image and a route image in a road-tracking automatic driving mode. First, the navigation device 50 determines whether start of road-tracking automatic driving in the road-tracking automatic driving mode in which a traveling lane or a traveling road is maintained by determining whether a button for selecting the automatic driving mode is operated in a state in which a destination is not set (Step S100). Then, when it is determined that the start of the road-tracking automatic driving is received, the automatic driving control unit 100 recognizes a current traveling lane of the vehicle M using the vehicle position recognizing unit 122 (Step S102). Then, the target lane determining unit 61 determines the current traveling lane of the vehicle M as a target lane, and the behavior planning unit 130 generates a target path on the basis of the determined target lane (Step S104). Accordingly, the vehicle system 1 can cause the vehicle M to travel in the road-tracking automatic driving mode.

Then, the navigation device 50 acquires a predetermined number of pieces of event point information from the position of the vehicle M in the traveling lane (Step S106). Then, the navigation device 50 predicts an arrival time and a distance to each event point on the basis of the acquired current position and the event point information (Step S108). Then, the navigation device 50 displays the point guidance image 300B (or 300C) and the route image 400B (or 400C) (Step S110).

In Step S110, the navigation device 50 displays the end notification image 350 (or 350A) including information on a branch point of a road including the traveling lane of the vehicle M or a point at which the road-tracking automatic driving ends. The navigation device 50 includes at least one of a distance and a traveling time to a branch point of a road including the traveling lane of the vehicle M or the point at which the road-tracking automatic driving ends as the information on a branch point of a road including the traveling lane of the vehicle M or the point at which the road-tracking automatic driving ends. A branch point is a point other than a junction (for example, an interchange) of the road including the traveling lane of the vehicle M and a road connected to an exit of a toll road.

Then, the navigation device 50 determines whether an operation of instructing automatic lane change has received before the branch road (Step S112). The navigation device 50 returns the process flow to Step S102 when it is determined that an operation of instructing automatic lane change has not been received. When an operation of instructing automatic lane change has been received, the navigation device 50 changes the point guidance image 300B (or 300C) and the route image 400B (or 400C) to the point guidance image 300D and the route image 400D including display frames 310 corresponding to event points which are present in a connected road of a branch destination (Step S114).

It has been described that the traveling lane of the vehicle M is switched to a lane of the branch road in Step S114, but the invention is not limited thereto. The navigation device 50 can change the point guidance image 300 and the route image 400 displayed on the display unit 55 to the point guidance image 300 and the route image 400 of a road on which the vehicle M travels along a lane to which the traveling lane is automatically switched by the automatic lane change.

Then, the behavior planning unit 130 determines whether the road-tracking automatic driving mode should be ended (Step S116). For example, when the vehicle M arrives at a point at which the target path ends, the behavior planning unit 130 determines that the road-tracking automatic driving mode should be ended. When it is determined that the road-tracking automatic driving mode should not be ended, the behavior planning unit 130 returns the process flow to Step S102. When it is determined that the road-tracking automatic driving mode should be ended, the behavior planning unit 130 ends the process flow of the flowchart.

As described above, when the road-tracking automatic driving in which the vehicle M travels automatically while maintaining a traveling lane or a traveling road without setting a destination is performed, the vehicle system 1 displays at least one of a distance and a traveling time from the position of the vehicle M to a branch point of the traveling road or a point at which the road-tracking automatic driving ends on the display unit 55. Accordingly, according to the vehicle system 1, it is possible to allow an occupant to recognize a branch point in a traveling road by road-tracking automatic driving even when a route is not set by the navigation device 50. According to the vehicle system 1, it is possible, to allow an occupant to recognize a point at which the road-tracking automatic driving ends. As a result, according to the vehicle system 1, it is possible to notify an occupant of an opportunity of performing manual driving in road-tracking automatic driving and to further enhance convenience.

In the vehicle system 1, when handover control of switching an automatic driving mode to a manual driving mode at a point at which road-tracking automatic driving ends or a branch point, the HMI 30 may notify an occupant of the vehicle of a handover request in advance. An occupant has a desire for knowing a time at which the handover request is notified in the future when the vehicle M starts the road-tracking automatic driving. In this regard, at least one of a distance and a traveling time from the position of the vehicle M to a branch point of a traveling road or a point at which the road-tracking automatic driving ends can be displayed as a reference in which a time at which the handover request is notified arrives. Accordingly, according to the vehicle system 1, it is possible to further enhance convenience.

According to the vehicle system 1, since the road-tracking traveling route image 330# is displayed in an area corresponding to a section in which road-tracking automatic driving is possible among areas interposed between the display frames 310, it is possible to recognize to what point in the point guidance image 300 road-tracking automatic driving is possible.

According to the vehicle system 1, since the road-tracking traveling route images 430# are arranged and displayed in the point guidance image, it is possible to more easily recognize whether road-tracking automatic driving is possible.

According to the vehicle system 1, when road-tracking automatic driving is performed and an operation of instructing automatic lane change is received before a branch road, the display screen is switched to the point guidance image 300 in which the display frames 310 for displaying information on event points in the branch road are arranged from a position closest to a start point of the branch road and thus it is possible to update the point guidance image 300 before the vehicle M actually enters the branch road. Accordingly, according to the vehicle system 1, it is possible to allow an occupant to recognize event points on a connected road at an earlier time.

According to the vehicle system 1, since an image indicating a branch road in which road-tracking automatic driving is possible is arranged and displayed in the changed point guidance image, it is possible to allow an occupant to more easily recognize that the vehicle M enters the connected road.

According to the vehicle system 1, since at least one of a distance and a traveling time to a branch point other than a junction point of a traveling road and a road connected to an exit of a toll road is displayed, a branch road connected to an interchange is not displayed and it is thus possible to suppress a display frequency of a branch point. Accordingly, according to the vehicle system 1, it is possible to reduce troubles due to frequent displaying of a branch point.

While embodiments of the invention have been described above, the invention is not limited to the embodiments and can be subjected to various modifications and substitutions without departing from the gist of the invention.

What is claimed is:

1. An information display device comprising:
an automatic driving control unit configured to perform automatic driving, the automatic driving including at least road-tracking automatic driving in which a vehicle travels automatically while maintaining a traveling lane or a traveling road without setting a destination; and
a display control unit configured to display at least one of a distance and a traveling time from a position of the vehicle to a branch point of the traveling road in which the vehicle travels or a point at which the road-tracking automatic driving ends on a display unit when the road-tracking automatic driving is performed by the automatic driving control unit.

2. The information display device according to claim 1, wherein the display control unit displays at least one of the distance and the traveling time from the position of the vehicle to the branch point of the traveling road in which the vehicle travels or the point at which the road-tracking automatic driving ends in a part of a point guidance image in which information on event points included in the traveling road in which the vehicle travels is arranged sequentially from a position closest to the position of the vehicle.

3. The information display device according to claim 2, wherein the display control unit displays information indicating a section in which the road-tracking automatic driving is possible in an area corresponding to the section in which the road-tracking automatic driving is possible among areas interposed between display frames in which the information on the event points is displayed.

4. The information display device according to claim 2, wherein the display control unit arranges and displays an image indicating a road in which the road-tracking automatic driving is possible in the point guidance image.

5. The information display device according to claim 2, further comprising a reception unit configured to receive an operation of instructing automatic lane change,
wherein the display control unit changes the point guidance image to a point guidance image in which information on event points included in a branch road is arranged sequentially from a position closest to the position of the vehicle when an operation of changing the traveling road in which the vehicle travels to the branch road is received by the reception unit before the branch road.

6. The information display device according to claim 5, wherein the display control unit arranges and displays an image indicating a branch road in which the road-tracking automatic driving is possible in the changed point guidance image.

7. The information display device according to claim 1, wherein the branch point is a point other than a junction point of the traveling road in which the vehicle travels and a road connected to an exit of a toll road.

8. An information display method in which a computer:
performs road-tracking automatic driving in which a vehicle travels automatically while maintaining a traveling lane or a traveling road without setting a destination; and
displays at least one of a distance and a traveling time from a position of the vehicle to a branch point of the traveling road in which the vehicle travels or a point at which the road-tracking automatic driving ends on a display unit.

9. An information display program causing a computer to execute a process of:
performing road-tracking automatic driving in which a vehicle travels automatically while maintaining a traveling lane or a traveling road without setting a destination; and
displaying at least one of a distance and a traveling time from a position of the vehicle to a branch point of the traveling road in which the vehicle travels or a point at which the road-tracking automatic driving ends on a display unit.
